(19) United States
(12) Patent Application Publication
(10) Pub. No.: US 2020/0352150 A1
(43) Pub. Date: Nov. 12, 2020

(54) UTILITY BOX COMPARTMENT DIVIDER AND BAIT AND TACKLE STORAGE

(71) Applicant: Plano Molding Company, Plano, IL (US)

(72) Inventors: John WHALEN, Sheridan, IL (US); Neil KWIATOWSKI, Queens, NY (US); Mason UMHOLTZ, Sunnyvale, CA (US); Michael DAY, New York, NY (US); Charles PARADISE, Brooklyn, NY (US)

(21) Appl. No.: 16/871,241

(22) Filed: May 11, 2020

Related U.S. Application Data
(60) Provisional application No. 62/845,565, filed on May 9, 2019.

(51) Int. Cl. A01K 97/06; B65D 25/06

(52) U.S. Cl. CPC A01K 97/06; E05D 1/00; B65D 25/06

(57) ABSTRACT

A utility box or compartment divider system that includes one or more configurable storage compartments. The utility box or compartment divider system can comprise a divider mate and a divider unit having a countermate that engages the divider mate. The divider unit can include a plurality of apertures that allow molecules to flow freely therethrough. The divider unit can include a retainer compartment configured to hold an AC/AM device.

### CROSS-REFERENCE TO PRIOR APPLICATION

This application claims priority to and the benefit thereof from U.S. Provisional Patent Application No. 62/845,565, filed May 9, 2019, titled “Utility Box Compartment Divider and Bait and Tackle Storage,” the entirety of which is hereby incorporated herein by reference.

### FIELD OF THE DISCLOSURE

The disclosure relates generally to a utility box, and, more particularly to a divider and bait and tackle storage.

### SUMMARY OF THE DISCLOSURE

A utility box and a compartment divider system are disclosed that provide substantial advantages over existing storage solutions. The instant disclosure provides an easy to use, reconfigurable storage solution that can keep articles dry or oxidation-free through inclusion of moveable or replaceable divider units between compartments that allow for air to freely flow in, out or between compartments via apertures formed in the divider units, but that keep even the smallest articles from migrating between compartments. The divider units or dividers can be installed with an anticorrosion or anti-moisture (AC/AM) device that can absorb moisture or emit molecules that can prevent articles from oxidizing. The storage solution can keep articles such as, for example, spinner bait from becoming tangled with each other. A multilevel or deep utility box embodiments can allow for configuration of compartments to form deep (or long) compartments to store long articles such as spinner bait, thereby requiring a much smaller footprint or storage area to store the same number of articles than would otherwise be possible without tangling or otherwise adversely affecting the articles.

According to an aspect of the disclosure, a utility box that includes one or more configurable storage compartments is provided. According to another aspect of the disclosure, a compartment divider system is provided that can be configured to form one or more compartments. The utility box or compartment divider system comprises a divider mate and a divider unit having a countermate that engages the divider mate. The divider unit can include a plurality of apertures that allow molecules to flow freely therethrough. The utility box can comprise a recessed surface that receives a portion of the divider unit. The utility box can comprise multiple levels of compartments.

The utility box can comprise a divider that is perpendicularly oriented with respect to the divider unit. The divider can comprise a keyhole opening that retains the divider unit. The divider can be configured to slide along the divider unit. The divider unit can be configured to slide along the divider.

The divider unit can include a retainer compartment configured to hold an AC/AM device.

The divider unit can comprise a pair of body portions. The pair of body portions can form the retainer compartment when configured in a closed position. The divider unit can comprise an adjustable fastener that attaches the pair of body portions to each other and allows the pair of body portions to move with respect to each other. The adjustable fastener can comprise a living hinge.

The divider mate can comprise a guide. The guide can have a female dovetail shape.

The countermate can comprise a male dovetail shape. The countermate can have a pair of countermate portions that, when assembled, form the countermate.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an embodiment of a utility box that is constructed according to the principles of the disclosure.

FIG. 2 shows the utility box in FIG. 1 in an open position.

FIG. 3 shows a bottom portion of the utility box in FIGS. 1 and 2.

FIG. 4 shows an embodiment of a divider unit that is constructed according to the principles of the disclosure.

FIG. 5 shows an embodiment of a divider unit with a storage compartment, constructed according to the principles of the disclosure.

FIG. 6 shows an example of a plurality of divider units being installed in a bottom portion of a utility box, according to the principles of the disclosure.

FIG. 7 shows an example of a divider unit being installed in a portion of another embodiment of a utility box.

FIG. 8 shows another embodiment of a divider unit that is constructed according to the principles of the disclosure.

FIG. 9 shows a cross-cut view of another embodiment of a utility box that is constructed according to the principles of the disclosure.

The present disclosure is further described in the detailed description and drawings that follows.

### DETAILED DESCRIPTION OF THE DISCLOSURE

The embodiments of the disclosure and the various features and advantageous details thereof are explained more fully with reference to the non-limiting embodiments and examples that are described or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

A utility box can be made in any shape, size, color or material. The utility box can store articles such as, for example, bait, fishing tackle, weights, floats, tools, or any other item that might be useful to the user. The utility box can include one or more compartments. However, when storing small articles (for example, bait or fishing tackle), those articles tend to migrate within the utility box, even if the utility box is provisioned with two or more compartments, and dividers between the compartments. For instance, a multi-compartment utility box might have a gap between a lower-most portion of a removable divider and a floor surface of the utility box, or between an upper-most portion of the removable divider and a roof surface of the utility box, thereby allowing small articles to migrate between compartments.

If an attempt is made to close or eliminate the gaps, then articles that are vulnerable to oxidation (for example, corrosion or rusting) might oxidize (for example, corrode or rust) due to a lack of air flow between the compartments. When moisture is introduced to the inside of a utility box, it can be very difficult to remove the moisture. This problem can be especially exasperated when the utility box, for example, is used to store tackle in saltwater fishing environments.

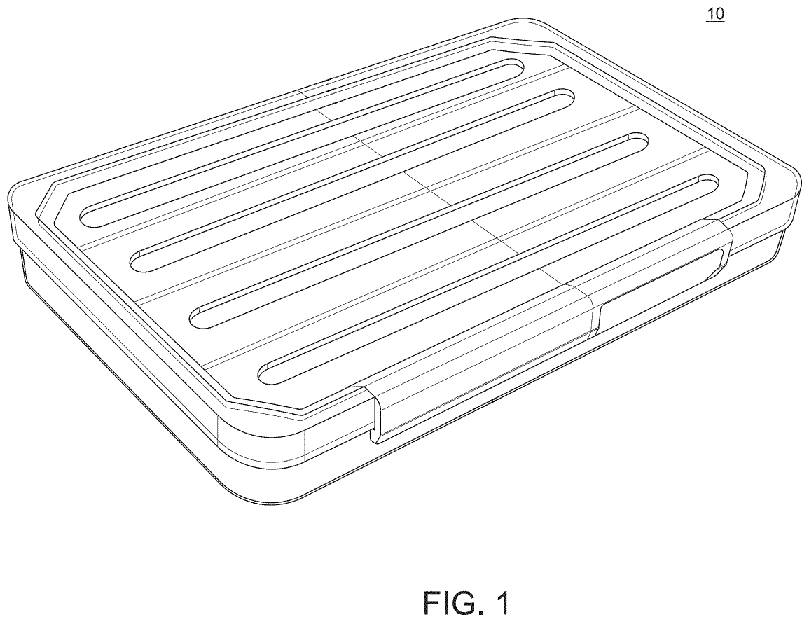

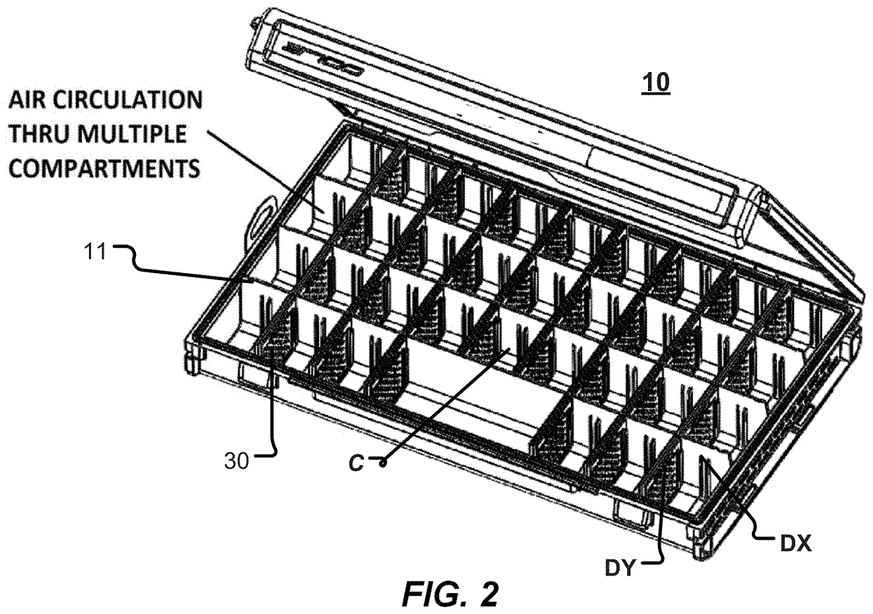

The instant disclosure provides a utility box and a compartment divider system that overcomes those problems. The disclosed utility box and compartment divider system prevent small articles from migrating between compartments while simultaneously allowing air to flow substantially unimpeded between the compartments. The compartment divider system can be equipped with an AC/AM device 40 (discussed below) to inhibit or prevent moisture in the utility box, or to inhibit or prevent oxidation of articles stored in the utility box. FIGS. 1 and 2 show an embodiment of the utility box and an embodiment of the compartment divider system, constructed according to the principles of the disclosure. The utility box can include the compartment divider system.

FIGS. 1 and 2 show a non-limiting embodiment of a utility box 10 that can include a non-limiting embodiment of a compartment divider system 11. The utility box 10 can include a front portion, a back portion, a top portion, a bottom portion, and a pair of side portions. The utility box 10 can be configured so the top portion can close and seal any articles in the utility box 10 when in the closed position (shown in FIG. 1), thereby holding the articles in the utility box 10 and preventing migration between compartments. The utility box is made such that small articles, when placed in a compartment (for example, compartment C, shown in FIG. 2), are retained in that compartment and prevented from migrating to another compartment. The utility box 10 is configured so that articles can be prevented from migrating between compartments when the utility box is open (shown in FIG. 2) or closed (shown in FIG. 1), or to outside of the utility box when the utility box is closed (shown in FIG. 1).

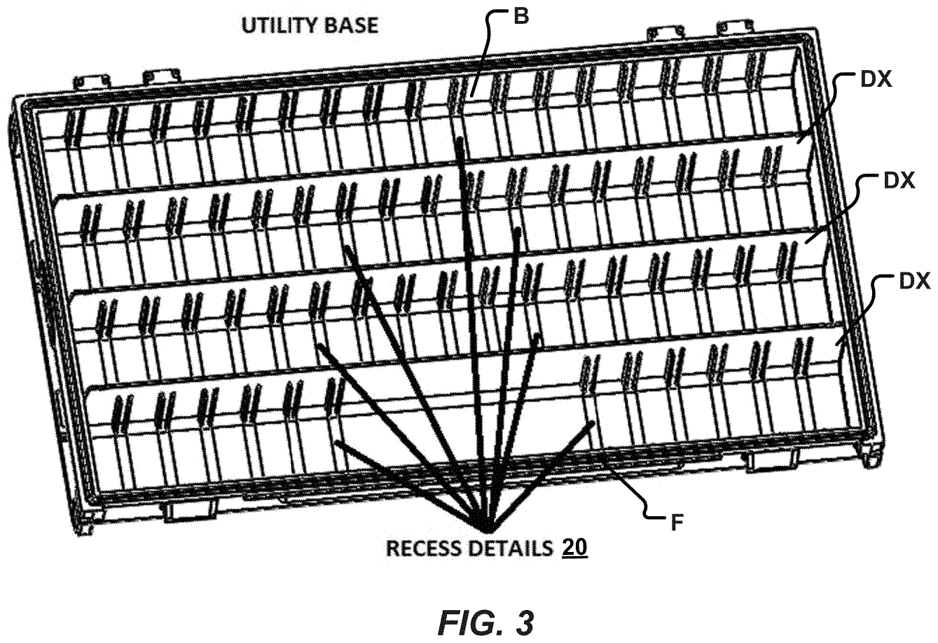

FIG. 2 shows the utility box 10 in an open position. The compartment divider system 11 can include a lengthwise divider DX or a widthwise divider DY, or both a lengthwise divider DX and widthwise divider DY. The compartment divider 11 can include one or more divider units 30. The lengthwise divider DX can include a structure (for example, a wall) that can be formed between or attached to opposing inner sidewalls of the utility box 10 to divide a space in the utility box 10 into at least two lengthwise compartments. The widthwise divider DY can include a structure (for example, a wall) that can be formed between or attached to an inner portion of a front wall F (shown in FIG. 3) and an inner portion of a back wall B (shown in FIG. 3) of the utility box 10 to divide a space in the utility box 10 into at least two widthwise compartments. The lengthwise divider DX or the widthwise divider DY can include one or more divider mates 20 (for example, shown in FIG. 3) to engage and secure a portion of the divider unit 30 to the divider mate 20 or to the divider DX, divider DY or wall of the utility box 10.

FIG. 3 shows an example of a bottom portion or base of the utility box 10. As seen in the non-limiting example in FIG. 3, the base can include three lengthwise dividers DX that divide the inner space of the utility box 10 into four main compartments. Each divider DX can include one or more divider mates 20 to engage one or more respective divider units 30 to divide a main compartment into two or more sub-compartments (for example, C, shown in FIG. 2).

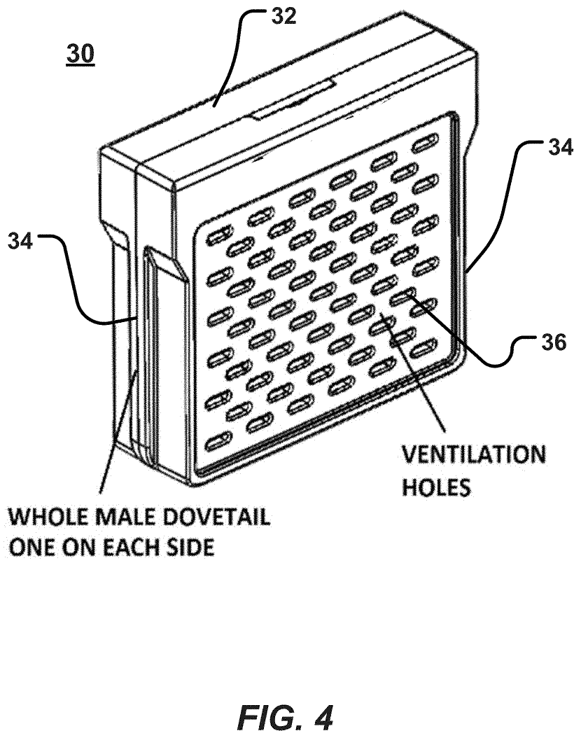

FIG. 4 shows an embodiment of a divider unit 30 that is constructed according to the principles of the disclosure. The divider unit 30 includes a divider body 32, a countermate 34, and one or more apertures 36. The apertures 36 can allow air to flow therethrough between compartments, or allow molecules to flow between divider unit 30 and an adjacent compartment, such as, for example, molecules emitted by or received by an AC/AM device 40 (discussed below). The divider unit 30 can include a panel (not shown) with apertures 36. The divider unit 30 can include a single countermate 34, or a countermate 34 on each of two opposing sides of the divider unit 30 (as seen in FIG. 4), or a single side and a bottom side of the divider unit 30 (not shown). In the non-limiting embodiment shown in FIG. 4, the countermate 34 includes a male or female dovetail on each of the sides of the divider unit 30. The countermate 34 can be configured to engage the divider mate 20 (shown in FIG. 3) on a divider DX or divider DY or an inner wall portion of the utility box 10 to secure the divider unit 30 to the divider DX or divider DY, or the utility box 10.

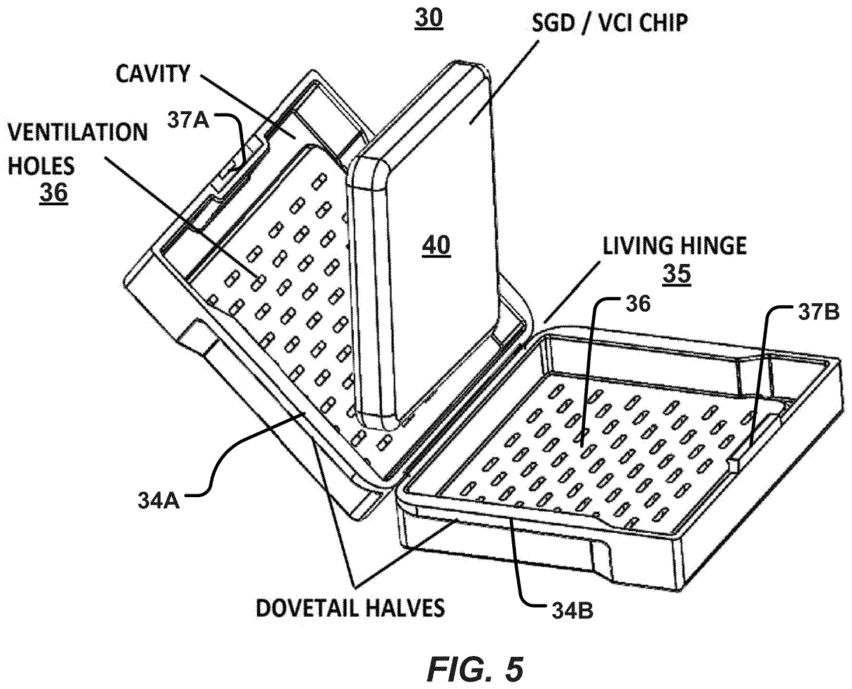

FIG. 5 shows an embodiment of the divider unit 30 with a storage compartment. The divider unit 30 can include a pair of body portions that, when positioned in the closed configuration (for example, shown in FIG. 4), form a storage compartment that can hold an article such as an anticorrosion or anti-moisture (AC/AM) device 40. The AC/AM device 40 can include, for example, a silicon gel desiccant, a volatile corrosion inhibitor (VCI), or any other anti-moisture or anticorrosion material that might be suitable for the type of articles to be stored in the utility box 10. The AC/AM 40 can be provided as a chip, a plate, a disc, a pellet, a powder, or any other structure or material that that can be retained in the storage compartment in the divider unit 30.

The pair of body portions can be fastened to each other at one end or side by an adjustable fastener 35 such as, for example, a hinge, a living hinge, or any other device that allows one body portion to pivot with respect to the other body portion, or a fixed fastener such as, for example, an adhesive, hook-and-loop, tongue and groove, rivet, screw, bolt, nut, pin, or any other device that can secure the pair of body portions to each other.

At an opposite end or side of each of the body portions, a fastener 37 (37A and 37B) can be provided to securely lock the pair of body portions to each other. The fastener 37 can include a female portion 37A and a male portion 37B. The fastener 37 can include a latch system or a fixed fastener such as an adhesive, hook-and-loop, tongue and tongue and groove, rivet, screw, bolt, nut, pin, or any other device that can secure the pair of body portions to each other.

The pair of body portions can be configured to align and clamp or snap together.

As seen in the non-limiting embodiment shown in FIG. 5, each countermate 34 can include a countermate portion 34A that is formed in a side portion of one body portion and a countermate portion 34B that is formed in a side portion of the second body portion. The countermate portions 34A and 34B can be configured to form the countermate 34 when the pair of body portions are positioned in the closed configuration (for example, shown in FIG. 4).

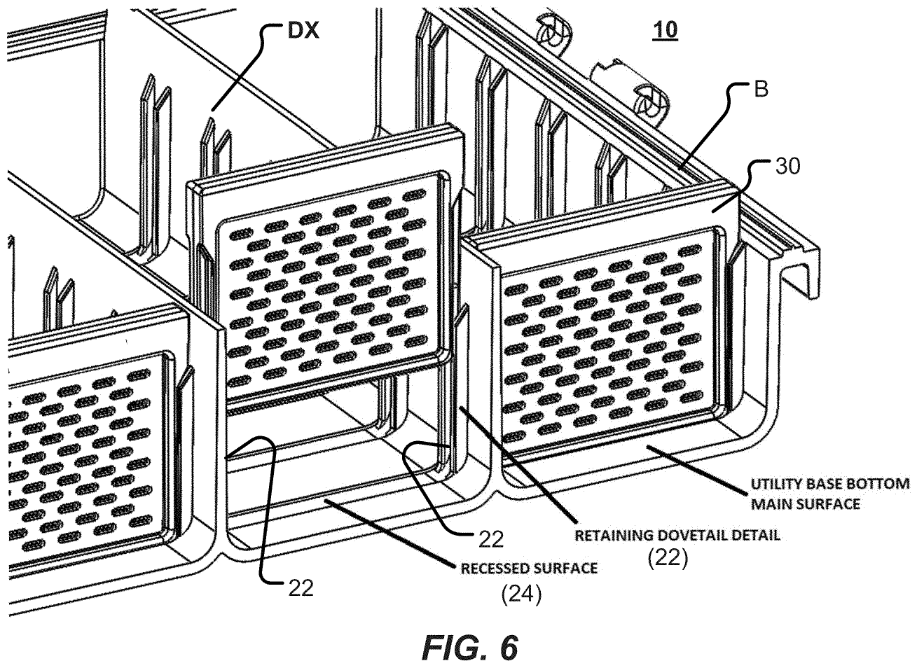

FIG. 6 shows an example of a cross-cut (widthwise) view of the utility box 10 and the compartment divider system 11 (shown in FIGS. 2 and 3). As seen in the non-limiting embodiment shown in FIG. 6, the compartment divider system 11 can include a plurality of divider mates 20 and one or more recessed surfaces 24. The recessed surfaces 24 can be formed in, for example, the bottom portion of the utility box. The compartment divider system 11 can include one or more divider units 30. One or more pairs of guides 22 can be formed on opposite sides of a compartment and a respective recessed surface 24 can be formed in an abutting side between the opposite sides, such as, for example, the floor of the utility box 10. Each guide 22 can receive, guide or hold a respective countermate 34 of the divider unit 30. A pair of opposing guides 22 can be configured to guide a divider unit 30 so that a bottom portion of the divider unit 30 is aligned with and guided into a seating position in the respective recessed surface 24 formed between the opposing guides, thereby reducing a chance that a small article might migrate into an opposing compartment. The guides 22 can include a female dovetail portion that can engage a male dovetail portion on the divider unit 30.

The compartment divider system 11 can be configured so that one or more recessed surfaces (not shown) are formed in an inner roof (or wall) surface of the top portion of the utility box 10. The roof recessed surfaces (not shown) can be positioned opposite respective recessed surfaces 24 so that divider units 30 can be seated between the respective recesses surfaces, in both the recessed surfaces 24 and respective opposite roof recessed surfaces (not shown). Alternatively, the inner roof surface of the top portion of the utility box 10 can be substantially flat and dimensioned so that the roof surface contacts the tops (or bottoms) of each divider unit 30, thereby retaining the divider units 30 in their seated positions when the top portion of the utility box 10 is in a closed position (for example, shown in FIG. 1).

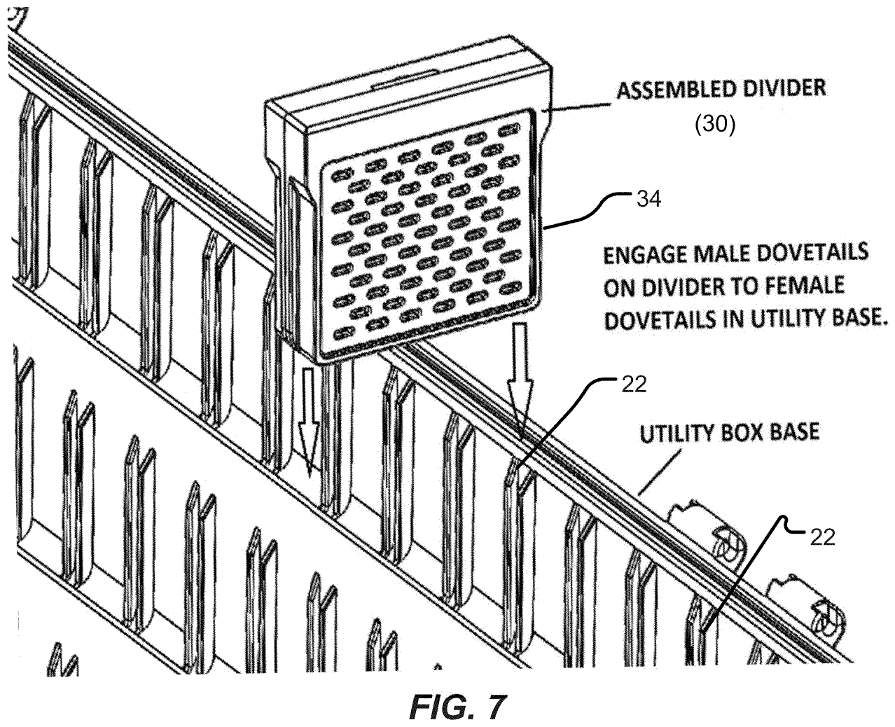

FIG. 7 shows a partial-view of an embodiment of the utility box having multiple levels, according to the principles of the disclosure. As seen in the non-limiting example in FIG. 7, the utility box can include multiple levels arranged vertically (or horizontally), each one of which can include a compartment divider system 11. The compartment divider system 11 can include one or more removable panels (not shown) that can be placed between levels in the multi-level utility box. The removable panel (not shown) can have recessed surfaces 24 (for example, as shown in FIG. 6) on one or both sides of the panel. The recessed surfaces 24 can be aligned with respective pairs of opposing guides 22 so that divider units 30 can be seated in the recessed surfaces 24. If pairs of oppositely positioned recessed surfaces 24 are provided (for example, recessed surfaces 24 formed in the floor of the utility box and oppositely located recessed surfaces 24 in the removable panel (not shown), which can be located above (or below) the guides 22, thereby sandwiching the divider units 30 between the removable panel (not shown) and the utility box floor, or another removable panel, or the inner roof surface of the multilevel utility box.

The compartment divider system 11 in the multilevel utility box can be configured so that removable panels (not shown) are optional. In this regard, the divider units 30 can be configured so that a bottom (or top) portion of a divider unit 30 (for example, shown in FIG. 7) can contact or engage a top (or bottom) portion of a divider unit 30 located below (or above) the divider unit 30, in the next level of the multilevel utility box. The absence of a removable panel between levels can allow for configuration of compartments for larger vertical (or horizontal) storage capacity.

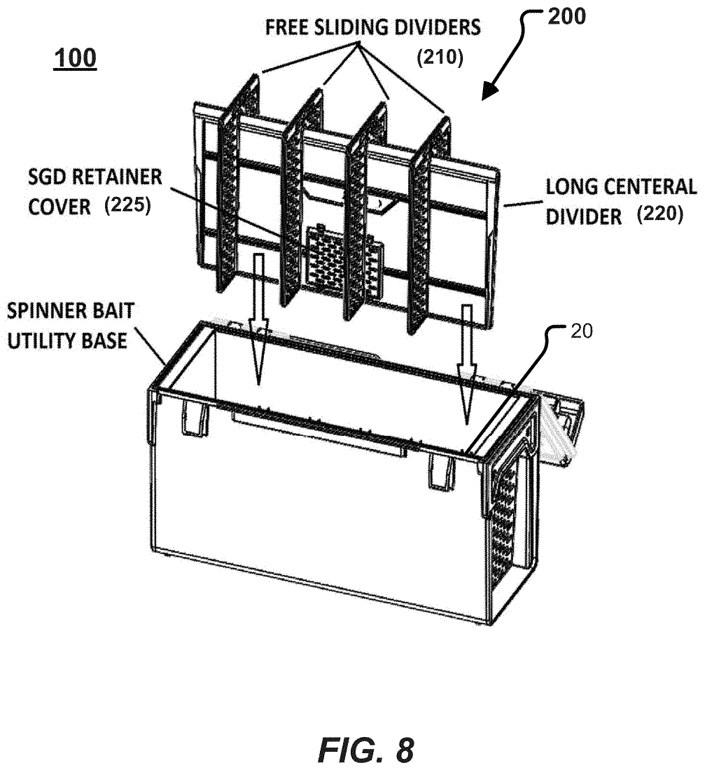

FIG. 8 shows another embodiment of a utility box 100 and another embodiment of a compartment divider system 200, both of which are constructed according to the principles of the disclosure. The utility box 100 can be configured to form a deeper storage compartment for storing articles that might benefit from a deeper (or longer) compartment, such as, for example, spinner bait. The utility box 100 can include a plurality of divider mates 20 (shown in FIGS. 2, 3, 6 and 7), with pairs of divider mates 20 affixed to or formed in the inner wall surfaces of opposing walls (for example, front and back walls) of the utility box 100. Each opposing pair of divider mates 20 can receive, guide and hold a divider 210. The divider mates 20 can be spaced at predetermined discrete distances along the inner wall(s) of the utility box 100 to allow for customizability of the compartment sizes. The inner walls of the utility box 100 can be substantially smooth to allow the dividers 210 to be moved to any desirable location within the utility box 100.

The compartment divider system 200 can include one or more first dividers 210 and one or more second dividers 220. The first dividers 210 can be moved along a length of the second divider(s) 220, so as to allow for desired configurations of compartments in the utility box 100. The second divider(s) 220 can be perpendicular to the first divider(s) 210, as seen in FIG. 8. The divider(s) 210 can be configured to freely slide along the length of the divider(s) 220. One or more of the dividers 210 or 220 can include a retainer 225.

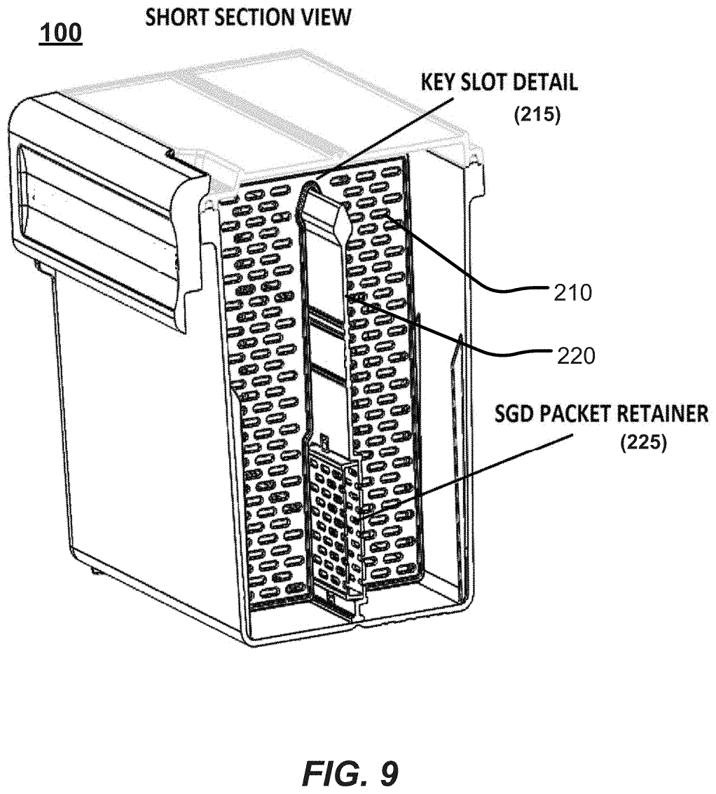

FIG. 9 shows a cross-cut view of the utility box 100 and compartment divider system 200. The divider 210 can include a plurality of apertures that allow airflow between compartments. The divider 210 can include a key slot opening 215 for the divider 220. The key slot opening 215 can allow the divider 210 to engage the divider 220 to provide a substantially rigid but adjustable structure, wherein the dividers 210 can be moved along the length of the divider 220 to allow for adjustably sized compartments. The divider 220 can include a snap-in detail (not shown) that can engage and snap-in the base of the utility box to security retain and affix the compartment divider system 200 to the utility box 100. The divider 220 (or divider 210) can include the retainer 225. The retainer 225 can include an openable (and closeable) cover to provide access to the inner compartment formed in the retainer 225 to allow for placement of an article in the compartment, such as, for example, the AC/AM device 40 (shown in FIG. 5). The retainer 225 can be formed integrally with, or affixed to the divider 220 (or 210). The retainer 225 can include a snap-on cover.

The instant disclosure provides a utility box design and a compartment divider system design that offer substantial advantages over existing storage solutions. For instance, the instant disclosure provides an easy to use, reconfigurable storage solution that can keep articles dry and oxidation-free through inclusion of moveable or replaceable divider units between compartments that allow for air to freely flow between compartments via apertures formed in the divider units, but that keep even the smallest articles from migrating between compartments. The divider units or dividers can be installed with an AC/AM device 40 to absorb moisture or to emit molecules that prevent articles from oxidizing. Since each of the dividers or divider units can include apertures, the entire internal storage volume of the utility box can be serviced by a single AC/AM devices 40, or additional AC/AM devices 40 can be provided.

The disclosure also provides a storage solution that keep articles such as, for example, spinner bait from becoming tangled with each other. For instance, the multilevel utility box (shown in FIG. 7) or the utility box 100 (shown in FIGS. 8 and 9) can allow for configuration of the divider units 30 or dividers 210 (or 220) to form deep (or long) compartments to store long articles such as spinner bait, thereby requiring a much smaller footprint or storage area to store the same number of articles than would otherwise be possible without tangling or otherwise adversely affecting the articles.

The terms “a,” “an,” and “the,” as used in this disclosure, means “one or more,” unless expressly specified otherwise.

The terms “including,” “comprising,” and variations thereof, as used in this disclosure, mean “including, but not limited to,” unless expressly specified otherwise.

Although process steps, method steps, or the like, may be described in a sequential order, such processes and methods can be configured to work in alternate orders. In other words, any sequence or order of steps that may be described does not necessarily indicate a requirement that the steps be performed in that order. The steps of the processes or methods described herein can be performed in any order practical. Further, some steps can be performed simultaneously.

When a single structure or article is described herein, it will be readily apparent that more than one device or article may be used in place of a single device or article. Similarly, where more than one device or article is described herein, it will be readily apparent that a single structure or article may be used in place of the more than one structure or article. The functionality or the features of a structure or article may be alternatively embodied by one or more other structures or articles that are not explicitly described as having such functionality or feature.

While the disclosure has been described in terms of exemplary embodiments, those skilled in the art will recognize that the disclosure can be practiced with modifications in the spirit and scope of the instant disclosure. These examples given above are merely illustrative and are not meant to be an exhaustive list of all possible designs, embodiments, applications or modifications of the disclosure.

What is claimed is:

1. A utility box that includes one or more configurable storage compartments, the utility box comprising:
a divider mate; and
a divider unit having a countermate that engages the divider mate,
wherein the divider unit includes
a plurality of apertures that allow molecules to flow freely therethrough, and
a retainer compartment configured to hold an anticorrosion device.

2. The utility box in claim 1, wherein the divider unit comprises a pair of body portions.

3. The utility box in claim 2, wherein the pair of body portions form the retainer compartment when configured in a closed position.

4. The utility box in claim 1, wherein the divider mate comprises a guide.

5. The utility box in claim 4, wherein the guide has a female dovetail shape.

6. The utility box in claim 1, wherein the countermate has a male dovetail shape.

7. The utility box in claim 1, wherein the countermate has a pair of countermate portions that, when assembled, form the countermate.

8. The utility box in claim 1, further comprising:
a recessed surface that receives a portion of the divider unit.

9. The utility box in claim 2, further comprising an adjustable fastener that attaches the pair of body portions to each other and allows the pair of body portions to move with respect to each other.

10. The utility box in claim 9, wherein the adjustable fastener comprises a living hinge.

11. The utility box in claim 1, further comprising multiple levels of compartments.

12. The utility box in claim 1, further comprising:
a divider perpendicularly oriented with respect to the divider unit.

13. The utility box in claim 12, wherein the divider comprises a keyhole opening that retains the divider unit.

14. The utility box in claim 12, wherein the divider is arranged to slide along the divider unit.

15. The utility box in claim 12, wherein the divider unit is arranged to slide along the divider.

16. A compartment divider system that is configurable to form one or more compartments, the system comprising:
a divider mate; and
a divider unit having a countermate that engages the divider mate,
wherein the divider unit includes
a plurality of apertures that allow molecules to flow freely therethrough, and
a retainer compartment configured to hold an anticorrosion device.

17. The compartment divider system in claim 16, wherein the divider unit comprises a pair of body portions.

18. The compartment divider system in claim 16, wherein the pair of body portions form the retainer compartment when configured in a closed position.

19. The compartment divider system in claim 16, wherein the divider mate comprises a guide having a female dovetail shape and the countermate has a male dovetail shape.

20. The compartment divider system in claim 16, wherein the countermate has a pair of countermate portions that, when assembled, form the countermate.
